(19) United States
(12) Patent Application Publication
(10) Pub. No.: US 2010/0254226 A1
(43) Pub. Date: Oct. 7, 2010

(54) Stepping motor control circuit and analog electronic watch

(76) Inventors: Kenji Ogasawara, Chiba-shi (JP); Saburo Manaka, Chiba-shi (JP); Akira Takakura, Chiba-shi (JP); Keishi Honmura, Chiba-shi (JP); Takanori Hasegawa, Chiba-shi (JP); Kosuke Yamamoto, Chiba-shi (JP); Kazumi Sakamoto, Chiba-shi (JP); Kazuo Kato, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/798,293

(22) Filed: Apr. 1, 2010

(30) Foreign Application Priority Data
Apr. 2, 2009 (JP) 2009-090210

(51) Int. Cl. G04B 19/04; H02P 8/38

(52) U.S. Cl. 368/80; 318/696

(57) ABSTRACT

A stepping motor control circuit includes a rotation detecting means for detecting an induced signal generated by rotation of a rotor of a stepping motor, and detecting a rotation state of the stepping motor according to whether the induced signal exceeds a predetermined reference threshold voltage in a predetermined detection section, and a control means for controlling driving of the stepping motor by using any one of a plurality of main driving pulses having energy different from each other or a correction driving pulse having energy higher than energy of each main driving pulse according to a detection result of the rotation detecting means. The detection section is divided into a first section immediately after driving with the main driving pulse, a second section after the first section, a third section after the second section, and a fourth section after the third section, and the control means lengthens the third section subsequent to the second section when the rotation detecting means has detected an induced signal exceeding the reference threshold voltage in the second section, and controls the driving of the stepping motor by selecting a driving pulse based on a pattern of an induced signal in the first to fourth sections.

### BACKGROUND OF THE INVENTION

1. Field of the Invention

The present invention relates to a stepping motor control circuit and an analog electronic watch using the same.

2. Background Art

In the related art, a stepping motor is used for an analog electronic watch and the like. The stepping motor includes a stator provided with a rotor receiving hole and a position determining portion for determining a stop position of a rotor, the rotor provided in the rotor receiving hole, and a coil. Further, the stepping motor rotates the rotor by magnetic flux generated in the stator by an alternating signal supplied to the coil, and stops the rotor at a position corresponding to the position determining portion.

As a control scheme for the stepping motor, there has been used a correction driving scheme in which, when the stepping motor is driven by a main driving pulse, it is detected whether the stepping motor is rotated by detecting an induced signal generated by free vibration after rotation of the stepping motor, and the main driving pulse is changed to a main driving pulse having a different pulse width for the driving of the stepping motor according to the detection result, or the stepping motor is forcibly rotated by a correction driving pulse having a pulse width wider than that of a main driving pulse (for example, refer to JP-B-63-18148, JP-B-63-18149 and JP-B-57-18440).

Further, in WO2005/119377, when detecting the rotation of the stepping motor, a means for comparing a detection time with a reference time is provided in addition to the detection of the induced signal, after the stepping motor is rotated by a main driving pulse P11, a correction driving pulse P2 is output if an induced signal is less than a predetermined reference threshold voltage Vcomp, and a next main driving pulse P1 is changed to a main driving pulse P12 with energy higher than that of the main driving pulse P11 so that the stepping motor is driven by the main driving pulse P12. If the detection time when the stepping motor has been rotated by the main driving pulse P12 is earlier than the reference time, the main driving pulse P12 is changed to the main driving pulse P11, so that the stepping motor is rotated by the main driving pulse P1 according to a load during the driving thereof, resulting in reduction of current consumption.

However, a peak generation time of an induced signal generated by the free vibration of the rotor is advanced when driving energy is high as compared with a load but it is delayed when the driving energy is low as compared with the load. Further, due to the influence of variation of a train wheel load, variation of a peak voltage may be large according to the passage of time. Furthermore, since variation of a load occurs due to individual movements, it is difficult to perform stable driving pulse control based on the peak generation time of the induced signal.

In addition, when the stationary position of the rotor has been shifted due to the structural variation of the stepping motor, since the phase of a generated induced signal is shifted, even if there is a driving margin, it is determined that no driving margin exists on one polarity side and an ineffective pulse-up operation may be performed.

Moreover, in a pulse control scheme of changing energy of a driving pulse by varying the length of the pulse, a detection time is delayed by the difference of timing at which the driving pulse ends, so that misdetection may occur.

### SUMMARY OF THE INVENTION

It is an aspect of the present invention to perform driving control based on an appropriate driving pulse by exactly determining an extra driving force, and to exactly determine an extra driving force although the phase of an induced signal is shifted by variation of a stepping motor, and the like.

According to the invention, a stepping motor control circuit includes: a rotation detecting means for detecting an induced signal generated by rotation of a rotor of a stepping motor, and detecting a rotation state of the stepping motor according to whether the induced signal exceeds a predetermined reference threshold voltage in a predetermined detection section; and a control means for controlling driving of the stepping motor by using any one of a plurality of main driving pulses having energy different from each other or a correction driving pulse having energy higher than energy of each main driving pulse according to a detection result of the rotation detecting means, wherein the detection section is divided into a first section immediately after driving with the main driving pulse, a second section after the first section, a third section after the second section, and a fourth section after the third section, and the control means lengthens the third section subsequent to the second section when the rotation detecting means has detected an induced signal exceeding the reference threshold voltage in the second section, and controls the driving of the stepping motor by selecting a driving pulse based on a pattern of an induced signal in the first to fourth sections.

The control means lengthens the third section subsequent to the second section when the rotation detecting means has detected the induced signal exceeding the reference threshold voltage in the second section, and controls the driving of the stepping motor by selecting the driving pulse based on the pattern of the induced signal in the first to fourth sections.

Herein, when the rotation detecting means has detected the induced signal exceeding the reference threshold voltage in the first section, the control means may be configured not to lengthen the third section subsequent to the second section although the rotation detecting means has detected the induced signal exceeding the reference threshold voltage in the second section subsequent to the first section.

Further, when the third section is lengthened, the control means may be configured to shorten the fourth section subsequent to the third section such that the length of the detection section is not changed.

Furthermore, the main driving pulses may have a comb-tooth shape and pulse widths of the main driving pulses may be equal to each other.

Further, according to the present invention, there is provided a stepping motor control circuit including: a rotation detecting means for detecting an induced signal generated by rotation of a rotor of a stepping motor, and detects a rotation state of the stepping motor according to whether the induced signal exceeds a predetermined reference threshold voltage in a predetermined detection section; and a control means for controlling driving of the stepping motor by using any one of a plurality of main driving pulses having energies different from each other or a correction driving pulse having energy higher than energy of each main driving pulse according to a detection result of the rotation detecting means, wherein the detection section is divided into a first section immediately after driving with the main driving pulse, a fifth section after the first section, a sixth section after the fifth section, a third section after the sixth section, and a fourth section after the third section, and the control means lengthens the third section immediately after the fifth section by a first predetermined length when the rotation detecting means has not detected an induced signal exceeding the reference threshold voltage in the first section and has detected the induced signal in the fifth section, and controls the driving of the stepping motor by selecting a driving pulse based on a pattern of an induced signal in the first, third and sixth sections.

The control means lengthens the third section immediately after the fifth section by the first predetermined length when the rotation detecting means has not detected the induced signal exceeding the reference threshold voltage in the first section and has detected the induced signal in the fifth section, and controls the driving of the stepping motor by selecting the driving pulse based on the pattern of the induced signal in the first, third and sixth sections.

Herein, the control means may be configured to lengthen the third section subsequent to the sixth section by a second predetermined length longer than the first predetermined length when the rotation detecting means has not detected the induced signal exceeding the reference threshold voltage in the first section and the fifth section and has detected the induced signal in the sixth section, and control the driving of the stepping motor by selecting a driving pulse based on a pattern of an induced signal in the first, third and sixth sections.

Further, when the third section is lengthened, the control means may be configured to shorten the fourth section subsequent to the third section.

Furthermore, the main driving pulses may have a rectangular waveform shape and pulse widths of the main driving pulses may be different from each other.

In addition, according to the present invention, there is provided an analog electronic watch including: a stepping motor for rotating time hands; and a stepping motor control circuit for controlling the stepping motor, wherein the above-described stepping motor control circuit is used as the stepping motor control circuit.

According to the stepping motor control circuit of the present invention, driving control based on an appropriate driving pulse can be performed by exactly determining an extra driving force, and the extra driving force can be exactly determined although the phase of an induced signal is shifted by variation of a stepping motor, and the like.

In addition, according to the analog electronic watch of the present invention, the driving control based on the appropriate driving pulse can be performed by exactly determining the extra driving force, and the extra driving force can be exactly determined although the phase of the induced signal is shifted by the variation of the stepping motor, and the like, so that a time counting operation can be exactly performed.

### BRIEF DESCRIPTION OF THE DRAWINGS

FIG. 1 is a block diagram illustrating an analog electronic watch according to an embodiment of the invention;

FIG. 2 is a diagram illustrating the configuration of a stepping motor used for an analog electronic watch according to an embodiment of the invention;

FIG. 3 is a timing diagram illustrating the operations of a stepping motor control circuit and an analog electronic watch according to an embodiment of the invention;

FIG. 4 is a timing diagram illustrating the operations of a stepping motor control circuit and an analog electronic watch according to an embodiment of the invention;

FIG. 5 is a timing diagram illustrating the operations of a stepping motor control circuit and an analog electronic watch according to an embodiment of the invention;

FIG. 6 is a timing diagram illustrating the operations of a stepping motor control circuit and an analog electronic watch according to an embodiment of the invention;

FIG. 7 is a determination chart illustrating the operations of a stepping motor control circuit and an analog electronic watch according to an embodiment of the invention;

FIG. 8 is a timing diagram illustrating the operations of a stepping motor control circuit and an analog electronic watch according to another embodiment of the invention;

FIG. 9 is a timing diagram illustrating the operations of a stepping motor control circuit and an analog electronic watch according to another embodiment of the invention;

FIG. 10 is a timing diagram illustrating the operations of a stepping motor control circuit and an analog electronic watch according to another embodiment of the invention;

FIG. 11 is a determination chart illustrating the operations of a stepping motor control circuit and an analog electronic watch according to another embodiment of the invention;

FIG. 12 is a flowchart illustrating a stepping motor control circuit and an analog electronic watch according to an embodiment of the invention; and

FIG. 13 is a flowchart illustrating a stepping motor control circuit and an analog electronic watch according to another embodiment of the invention.

### DETAILED DESCRIPTION OF THE INVENTION

Hereinafter, a motor control circuit and an analog electronic watch according to an embodiment of the present invention will be described with reference to the accompanying drawings. Further, in the drawings, the same reference numerals are used to designate the same elements.

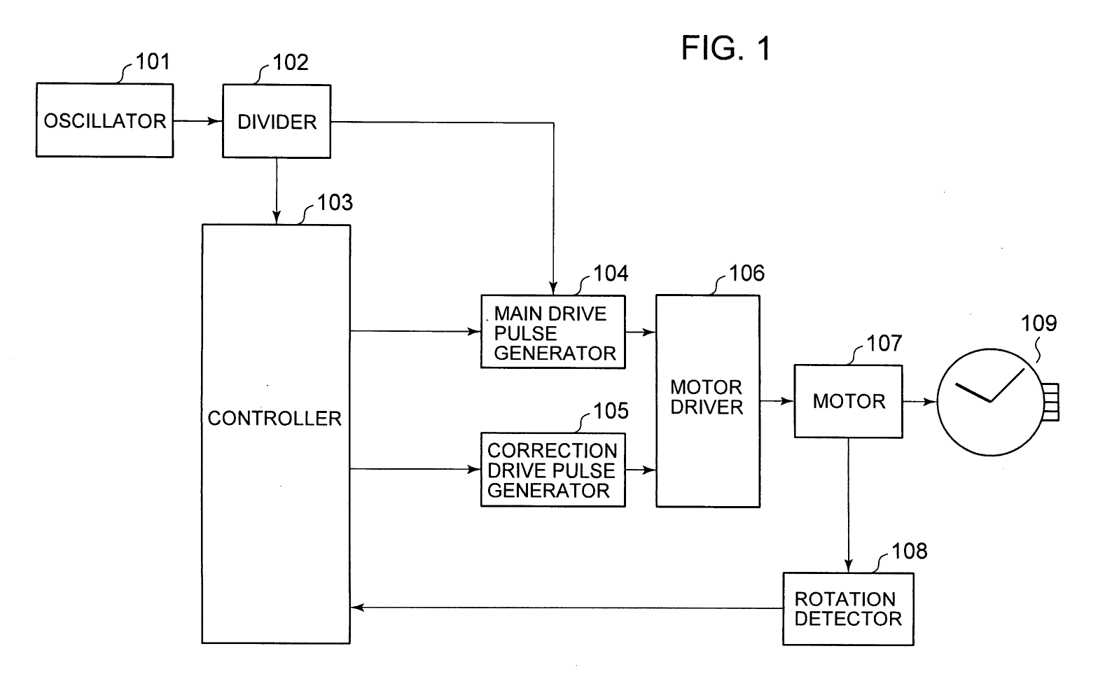

FIG. 1 is a block diagram illustrating an analog electronic watch using a stepping motor control circuit according to the embodiment of the present invention, which illustrates the example of an analog electronic wrist watch.

First, the outline of the present embodiment will be described. A detection section T for detecting rotation of a stepping motor is divided into a first section T1a immediately after driving with a main driving pulse, a second section T1b after the first section T1a, a third section T2 after the second section T1b, and a fourth section T3 after the third section T2.

In a normal load state (for example, a state in which a load of the stepping motor 107 is used only for time hands), the first section serves as a section for determining a rotation state of a rotor in the forward direction in a third quadrant of an XY coordinate space employing the rotor as the center, the second section serves as a section for determining the rotation state of the rotor in the forward direction and the initial rotation state of the rotor in the backward direction in the third quadrant, the third section serves as a section for determining the initial rotation state of the rotor in the backward direction in the third quadrant, and the fourth section serves as a section for determining the rotation state of the rotor after the initial rotation of the rotor in the backward direction in the third quadrant.

When the rotor does not have enough power to rotate, an induced signal VRs generated by free vibration after the rotation of the stepping motor continuously appears in the first section T1a and the second section T1b, thereby representing that extra rotation power is reduced.

When driving energy of a main driving pulse P1 is normal driving energy or a driving force is slightly reduced, since an interruption timing of a main driving pulse exceeds the first section T1a, an induced signal VRs exceeding a predetermined reference threshold voltage Vcomp does not appear in the first section T1a and appears after the second section T1b.

Since a peak generation time of both of the induced signals VRs occurs in the second section T1b, determination regarding the former or the latter is impossible. However, the rotation state of the rotor having no extra force, normal driving, a state in which a driving force is slightly reduced and the like can be distinguished from each other through a combination with a detection result of the induced signal VRs of the first section T1a.

Based on such characteristics, driving control with an appropriate driving pulse is performed by exactly determining an extra driving force. According to the present embodiment, when the induced signal VRs exceeds the predetermined reference threshold voltage Vcomp in the second section T1b (when a determination value is “1”), the rotation state of the rotor is determined as slight rotation and the rank of the main driving pulse P1 is allowed to be up by one rank. In this way, since driving with a correction driving pulse P2 is not performed and efficient correction driving pulse control is possible, low power consumption can be achieved.

Further, according to the present embodiment, the rotation state of the rotor can be detected using the induced signal VRs in the detection sections of the first section T1a and the second section T1b, and it is possible to determine maintenance of a pulse with the same driving energy or change to a pulse with small energy.

For example, it is possible to perform a change to a driving pulse with energy changed based on a result obtained by comparing the induced signal VRs with the reference threshold voltage Vcomp. In detail, when the induced signal VRs of the first section T1a exceeds the reference threshold voltage Vcomp and the induced signal VRs of the third section T2 exceeds the reference threshold voltage Vcomp, the main driving pulse P1 is not changed and the main driving pulse P1 with the same energy is maintained.

In this way, normal driving, the rotation state of the rotor in which a driving force is slightly reduced, the rotation state in which the rotor does not have enough power to rotate and the like can be apparently determined, and erroneous determination can be prevented. Further, behavior of the rotor up to just before the rotor is in a non-rotation state can be detected using the induced signal VRs and it is possible to efficiently control whether to perform driving control with the correction driving pulse P2, so that low power consumption can be achieved.

In addition, according to the present embodiment, when the induced signal VRs exceeding the reference threshold voltage Vcomp has been detected in the second section T1b, the third section T2 subsequent to the second section is lengthened by a predetermined time, so that driving control with an appropriate driving pulse can be performed by exactly determining an extra driving force although the phase of the induced signal VRs has been shifted due to the structural variation of the stepping motor. Consequently, efficient correction driving pulse control is possible, so that low power consumption can be achieved.

Hereinafter, the embodiment of the present invention will be described in detail.

In FIG. 1, the analog electronic watch includes an oscillating circuit 101, a divider circuit 102, a control circuit 103 and a main driving pulse generating circuit 104. The oscillating circuit 101 generates a signal with a predetermined frequency. The divider circuit 102 divides the signal generated by the oscillating circuit 101 to generate a watch signal serving as a reference of a watch. The control circuit 103 controls electronic circuit elements constituting the electronic watch or controls the change of a driving pulse. The main driving pulse generating circuit 104 selects a main driving pulse P1, which corresponds to a pulse control signal from the control circuit 103, from a plurality of main driving pulses P1 for stepping motor rotation driving, and outputs the selected main driving pulse P1.

Further, the analog electronic watch includes a correction driving pulse generating circuit 105, a motor driver circuit 106, a stepping motor 107, an analog display unit 109 and a rotation detecting circuit 108. The correction driving pulse generating circuit 105 outputs a correction driving pulse P2 for forcibly rotating the stepping motor 107 based on the pulse control signal from the control circuit 103. The motor driver circuit 106 rotates the stepping motor 107 in response to the main driving pulse P1 from the main driving pulse generating circuit 104 and the correction driving pulse P2 from the correction driving pulse generating circuit 105. The analog display unit 109 is rotated by the stepping motor 107 and is provided with time hands for displaying a time. The rotation detecting circuit 108 detects the induced signal VRs, which is generated according to the rotation of the stepping motor 107, in a predetermined detection period.

The control circuit 103 serves as a section determining circuit which compares the time, at which the rotation detecting circuit 108 has detected the induced signal VRs exceeding the reference threshold voltage Vcomp due to the rotation of the stepping motor 107, with a section in which the induced signal VRs has been detected, and determines a detection section of the induced signal VRs. Herein, the detection period for determining whether the stepping motor 107 has rotated is divided into four sections.

The rotation detecting circuit 108 uses the principle equal to that of the rotation detection circuit according to JP-B-63-18148 and detects the induced signal VRs which is generated by free vibration after the rotation of the stepping motor 107 and exceeds the predetermined reference threshold voltage Vcomp.

Further, the oscillating circuit 101 and the divider circuit 102 constitute a signal generating means, and the analog display unit 109 constitutes a display means. The rotation detecting circuit 108 constitutes a rotation detecting means and the control circuit 103 constitutes a control means. The main driving pulse generating circuit 104 and correction driving pulse generating circuit 105 constitute a driving pulse generating means. In addition, the motor driver circuit 106 constitutes a motor driving means.

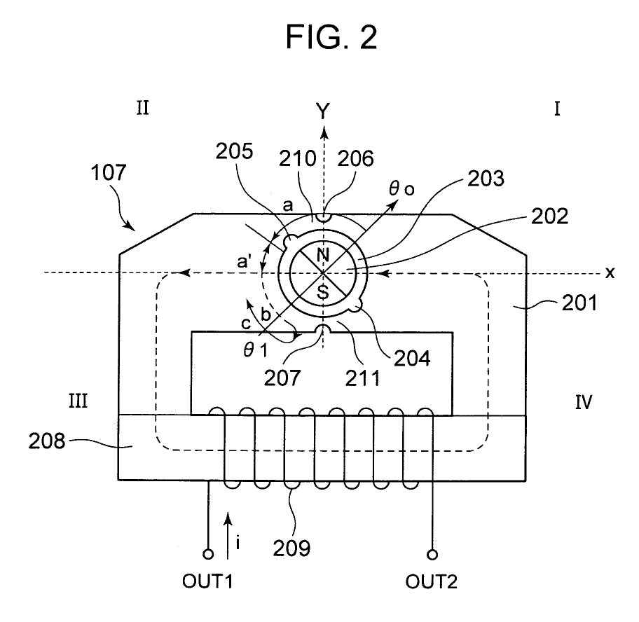

FIG. 2 is a diagram illustrating the configuration of the stepping motor 107 used for the embodiment of the present invention, which illustrates an example of a watch stepping motor generally used for an analog electronic watch.

In FIG. 2, the stepping motor 107 includes a stator 201 formed with a rotor receiving through hole 203, a rotor 202 rotatably provided in the rotor receiving through hole 203, a magnetic core 208 bonded to the stator 201, and a coil 209 wound around the magnetic core 208. When the stepping motor 107 is used for an analog electronic watch, the stator 201 and the magnetic core 208 are fixed to a ground plane (not shown) by screws (not shown) while being bonded to each other. The coil 209 has a primary terminal OUT1 and a secondary terminal OUT2.

The rotor 202 is magnetized to two poles (S and N poles). The stator 201 made of a magnetic material is formed at the outer end portion thereof with a plurality (two in the present embodiment) of cutout parts (outer notches) 206 and 207 which face each other while interposing the rotor receiving through hole 203 therebetween. Saturable parts 210 and 211 are provided between each of the notches 206 and 207 and the rotor receiving through hole 203.

The saturable parts 210 and 211 are not saturated by the magnetic flux of the rotor 202, but are saturated when the coil 209 is excited so that magnetic resistance becomes large. The rotor receiving through hole 203 is formed in circular hole shape in which a plurality (two in the present embodiment) of semilunar cutout parts (inner notches) 204 and 205 are integrally formed with each other at opposite positions of the through hole which is circular in outline.

The cutout parts 204 and 205 serve as position determining portions for determining a stop position of the rotor 202. In the state in which the coil 209 is not excited, the rotor 202 is stably stopped at a position corresponding to the position determining portions as illustrated in FIG. 2, in other words, a magnetic pole axis of the rotor 202 is stably stopped at a position (position of an angle of θ0) which is perpendicular to a line segment which connects the cutout part 204 to the cutout part 205. An XY coordinate space, in which a rotation axis (rotation center) of the rotor 202 is employed as a center, is divided into four quadrants (first to fourth quadrants I to IV).

If an electric current i flows in the arrow direction of FIG. 2 by a rectangular waveform driving pulse supplied between the terminals OUT1 and OUT2 of the coil 209 from the main driving pulse generating circuit 104 (e.g., the primary terminal OUT1 is referred to as a positive pole and the secondary terminal OUT2 is referred to as a negative pole), magnetic flux is generated in the stator 201 in the broken line arrow direction. Therefore, the saturable parts 210 and 211 are saturated so that magnetic resistance becomes large. Thereafter, due to an interaction between magnetic poles generated in the stator 201 and the magnetic poles of the rotor 202, since the rotor 202 is rotated at an angle of 180° in the forward direction (counterclockwise direction of FIG. 2), the magnetic pole axis of the rotor 202 is stably stopped at a position of an angle of θ1. Herein, the rotation direction, in which a normal operation (a hand moving operation in the electronic watch of the present embodiment) is performed by the rotation of the stepping motor 107, will be referred to as the forward direction, and the opposite will be referred to as the backward direction.

Next, if an electric current flows in the opposite arrow direction of FIG. 2 by a rectangular waveform driving pulse having a reverse polarity supplied between the terminals OUT1 and OUT2 of the coil 209 from the main driving pulse generating circuit 104 (the primary terminal OUT1 is referred to as a negative pole and the secondary terminal OUT2 is referred to as a positive pole such that reverse polarity occurs as compared with the above driving), magnetic flux is generated in the stator 201 in the direction opposite to the broken line arrow direction. Therefore, the saturable parts 210 and 211 are first saturated. Thereafter, due to the interaction between the magnetic poles generated in the stator 201 and the magnetic poles of the rotor 202, since the rotor 202 is rotated at the angle of 180° in the same direction (forward direction) as that in the above case, the magnetic pole axis of the rotor 202 is stably stopped at a position of the angle of θ0.

Then, the above operation is repeated by supplying the coil 209 with signals (alternating signals) having different polarities, so that the rotor 202 can be continuously rotated by 180° in the arrow direction. According to the present embodiment, as described later, a plurality of main driving pulses P10 to P1m having different energy and a correction driving pulse P2 are used as the driving pulse.

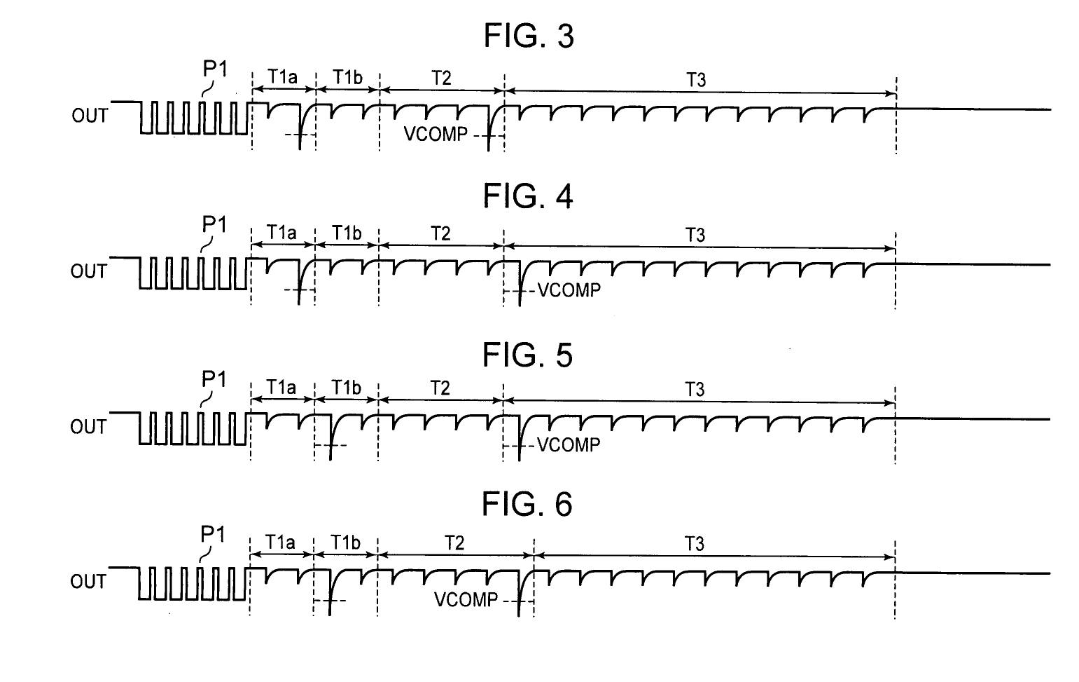

FIGS. 3 to 6 are timing diagrams when the stepping motor 107 is driven by the main driving pulse P1 according to the present embodiment.

In FIGS. 3 to 6, P1 denotes both a main driving pulse and a section in which the rotor 202 is rotated by the main driving pulse P1. Each main driving pulse P1 has a comb-tooth shape and a constant pulse width regardless of the magnitude of driving energy. Duty ratios of comb-teeth constituting each main driving pulse P1 are different from each other, so that the driving energy of each main driving pulse P1 is different from each other.

The detection section T is divided into the first section T1a which denotes a predetermined time immediately after driving with the main driving pulse P1, the second section T1b which denotes a predetermined time after the first section T1a, the third section T2 which denotes a predetermined time after the second section, and the fourth section T3 which denotes a predetermined time after the third section T2. In this way, the entire detection section T starting from immediately after the driving with the main driving pulse P1 is divided into a plurality of sections (in the present embodiment, four sections T1a, T1b, T2 and T3). However, in the present embodiment, a mask section, which is a period in which an induced signal is not detected, is not provided.

When the rotor 202 is employed as the center and the XY coordinate space area, in which the main magnetic pole of the rotor 202 is located by the rotation thereof, is divided into the first to fourth quadrants I to IV, the first to fourth sections T1a, T1b, T2 and T3 can be defined as follows.

That is, in a state of a load (normal load) in which the load is normally driven such as a case in which a load is used only for time hands, the first section T1a serves as a section for determining the rotation state of the rotor 202 in the forward direction (counterclockwise direction) in the third quadrant III, the second section T1b serves as a section for determining the rotation state of the rotor 202 in the forward direction and the initial rotation state of the rotor 202 in the backward direction (clockwise direction) in the third quadrant III, the third section T2 serves as a section for determining the initial rotation state of the rotor 202 in the backward direction in the third quadrant III, and the fourth section T3 serves as a section for determining the rotation state of the rotor 202 after the initial rotation of the rotor 202 in the backward direction in the third quadrant III.

Further, in a state in which a small load is added to the normal load (i.e., increase in a load is small), the first section T1a serves as a section for determining the rotation state of the rotor 202 in the second quadrant II, the second section T1b serves as a section for determining the rotation state of the rotor 202 in the second quadrant II and the initial rotation state of the rotor 202 in the forward direction in the third quadrant III, the third section T2 serves as a section for determining the initial rotation state of the rotor 202 in the forward direction and the initial rotation state of the rotor 202 in the backward direction in the third quadrant III, and the fourth section T3 serves as a section for determining the rotation state of the rotor 202 after the initial rotation of the rotor 202 in the backward direction in the third quadrant III.

The Vcomp serves as a reference threshold voltage for determining a voltage level of the induced signal VRs generated in the stepping motor 107. When the rotor 202 has performed a predetermined operation with a heavy load such as a case in which the stepping motor 107 has rotated, the reference threshold voltage Vcomp is set such that the induced signal VRs exceeds the reference threshold voltage Vcomp. However, when the rotor 202 does not perform the predetermined operation with the heavy load such as a case in which the stepping motor 107 does not rotate, the reference threshold voltage Vcomp is set such that the induced signal VRs does not exceed the reference threshold voltage Vcomp.

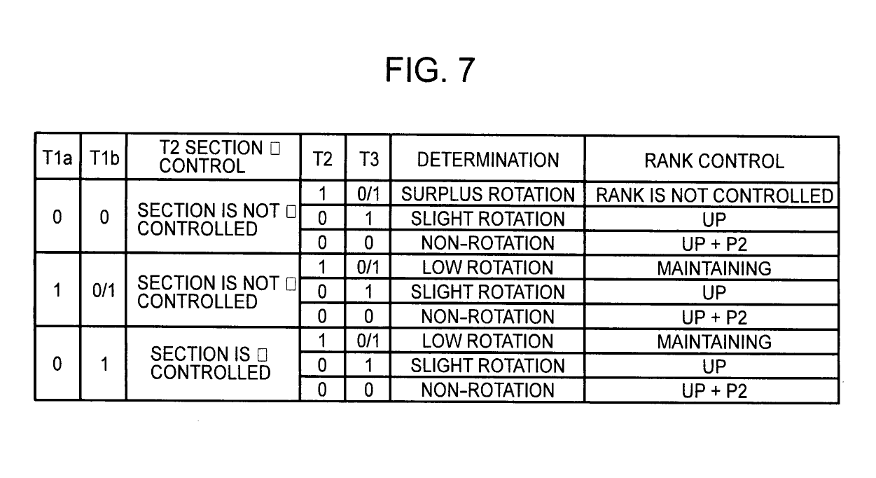

FIG. 7 is a determination chart obtained by collecting operations according to the present embodiment, which is stored in the control circuit 103 in advance. In FIG. 7, a determination value “1” is given when the rotation detecting circuit 108 has detected the induced signal VRs exceeding the reference threshold voltage Vcomp, and a determination value “0” is given when the rotation detecting circuit 108 cannot detect the induced signal VRs exceeding the reference threshold voltage Vcomp. Further, “0/1” represents that the determination value may have “1” or “0”.

As illustrated in FIG. 7, when the rotation detecting circuit 108 detects the existence of the induced signal VRs exceeding the reference threshold voltage Vcomp, the control circuit 103 generates a determination pattern (a determination value of the first section T1a, a determination value of the second section T1b, a determination value of the third section T2 and a determination value of the fourth section T3) for the detection time of the induced signal, and controls the main driving pulse generating circuit 104 and the correction driving pulse generating circuit 105 with reference to the determination chart of FIG. 7 stored in the control circuit 103. In detail, the control circuit 103 performs driving pulse control such as pulse up or pulse down of the main driving pulse P1 or driving with the correction driving pulse P2, thereby controlling the rotation of the stepping motor 107.

For example, in the case of a pattern (1, 0, 1, 0) as illustrated in FIG. 3, the control circuit 103 determines the driving of the stepping motor 107 driven by the main driving pulse P1 at that time as rotation (low rotation) with appropriate energy in which driving energy is not left, and maintains the rank of the main driving pulse P1 without changing the same (rank maintenance). In such a case, since the determination value of the first section T1a is “1” and the determination value of the second section T1b is “0”, the control circuit 103 determines that no phase shift of the induced signal VRs has occurred, and does not perform section control of the third section T2.

Further, in the case of a pattern (1, 0, 0, 1) as illustrated in FIG. 4, the control circuit 103 determines the driving of the stepping motor 107 driven by the main driving pulse P1 at that time as rotation (slight rotation) in which the driving energy is slightly left and non-rotation may be caused in the next driving, and quickly controls the rank of the main driving pulse P1 to be up by one rank (rank up) without performing driving with the correction driving pulse P2. In such a case, since the determination value of the first section T1a is “1” and the determination value of the second section T1b is “0”, the control circuit 103 determines that no phase shift of the induced signal VRs has occurred, and does not perform the section control of the third section T2.

Meanwhile, if it is assumed that a pattern (0, 1, 0, 1) as illustrated in FIG. 5 is generated, when the section control is not performed, the control circuit 103 determines the driving of the stepping motor 107 driven by the main driving pulse P1 at that time as slight rotation, and controls the rank of the main driving pulse P1 to be up by one rank (rank up).

However, according to the present embodiment, since the determination value of the first section T1a is “0” and the determination value of the second section T1b is “1”, the control circuit 103 determines that the phase shift of the induced signal VRs has occurred, and performs the section control of the third section T2, thereby lengthening the third section T2 subsequent to the second section T1b by a predetermined time as illustrated in FIG. 6. That is, the control circuit 103 determines that the pattern of FIG. 3 has been generated after being delayed by a constant time (the phase has been shifted), and lengthens the third section T2 by the predetermined time.

In this way, the control circuit 103 determines that a pattern generated by the driving with the main driving pulse P1 is (0, 1, 1, 0), and maintains the rank of the main driving pulse P1 without performing the rank up.

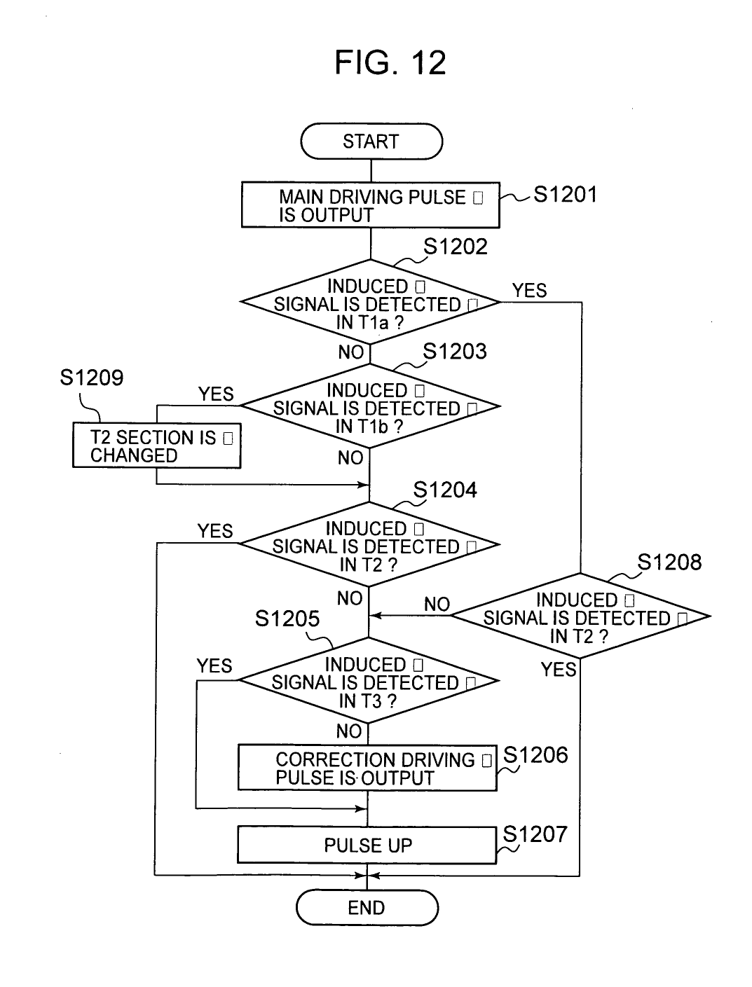

FIG. 12 is a flowchart illustrating the procedure of the present embodiment, which mainly illustrates the procedure of the control circuit 103.

Hereinafter, the operations of the stepping motor control circuit and the analog electronic watch according to the embodiment of the present invention will be described in detail with reference to FIGS. 1 to 7 and FIG. 12.

In FIG. 1, the oscillating circuit 101 generates a reference clock signal with a predetermined frequency, and the divider circuit 102 divides the signal generated by the oscillating circuit 101 to generate the watch signal serving as the reference of the watch, and outputs the watch signal to the control circuit 103 and the main driving pulse generating circuit 104.

The control circuit 103 outputs a main driving pulse control signal to the main driving pulse generating circuit 104 such that the stepping motor 107 is rotated by the main driving pulse P1 with predetermined energy (Step S1201). The main driving pulse generating circuit 104 outputs the corresponding main driving pulse P1 with the predetermined energy to the motor driver circuit 106 in response to the main driving pulse control signal. The motor driver circuit 106 rotates the stepping motor 107 by using the main driving pulse P1. The stepping motor 107 is rotated by the main driving pulse P1 to drive the display unit 109. Thus, when the stepping motor 107 normally operates, since the stepping motor 107 is configured to be reliably rotated by the main driving pulse P1, the display unit 109 normally performs current time display by using time hands.

The rotation detecting circuit 108 detects the induced signal VRs exceeding the reference threshold voltage Vcomp, and notifies the control circuit 103 of the point regarding the detection at the detection time point of the induced signal VRs.

When it is determined that the rotation detecting circuit 108 detects no induced signal VRs exceeding the reference threshold voltage Vcomp in any one of the first section T1a, the second section T1b, the third section T2 and the fourth section T3 (the stepping motor 107 is not rotated in any one of the first section T1a, the second section T1b, the third section T2 and the fourth section T3), that is, when it is determined that the detection pattern is (0, 0, 0, 0), in other words, when the rotation state of the stepping motor 107 is determined as non-rotation (Steps S1202, S1203, S1204 and S1205), the control circuit 103 outputs a correction driving pulse control signal to the correction driving pulse generating circuit 105 such that the correction driving pulse generating circuit 105 outputs the correction driving pulse P2 (Step S1206).

The correction driving pulse generating circuit 105 outputs the correction driving pulse P2 to the motor driver circuit 106 in response to the correction driving pulse control signal.

The motor driver circuit 106 rotates the stepping motor 107 by using the correction driving pulse P2. The stepping motor 107 is forcibly rotated by the correction driving pulse P2. As a result, the display unit 109 is driven to perform current time display and the like through the time hands.

Simultaneously, the control circuit 103 outputs a pulse up control signal to the main driving pulse generating circuit 104, thereby controlling the rank of the main driving pulse P1 to be up by one rank (Step S1207). The motor driver circuit 106 rotates the stepping motor 107 by using a main driving pulse after one rank up in the next driving.

In process step S1205, when it is determined that the rotation detecting circuit 108 has detected the induced signal VRs exceeding the reference threshold voltage Vcomp in the fourth section T3 (the detection pattern is (0, 0, 0, 1)), that is, when the rotation state of the stepping motor 107 is determined as slight rotation, the control circuit 103 proceeds to the process step S1207 to perform a pulse-up operation without outputting the correction driving pulse P2.

In process step S1204, when it is determined that the rotation detecting circuit 108 has detected the induced signal VRs exceeding the reference threshold voltage Vcomp in the third section T2 (the detection pattern is (0, 0, 1, 0/1)), that is, when the rotation state of the stepping motor 107 is determined as surplus rotation, the control circuit 103 performs no rank control of the main driving pulse P1.

In process step S1203, when it is determined that the rotation detecting circuit 108 has detected the induced signal VRs exceeding the reference threshold voltage Vcomp in the second section T1b (the initial pattern of two sections is (0, 1)), the control circuit 103 performs section control to lengthen the third section T2 by a predetermined time, and then proceeds to the process step S1204 (Step S1209) (refer to FIGS. 5 and 6).

Meanwhile, in process step S1202, in the case of determining that the rotation detecting circuit 108 has detected the induced signal VRs exceeding the reference threshold voltage Vcomp in the first section T1a, the control circuit 103 proceeds to the process step S1205 when determining that the induced signal VRs exceeding the reference threshold voltage Vcomp is not detected in the third section T2, and performs no rank control when determining that the induced signal VRs exceeding the reference threshold voltage Vcomp has been detected in the third section T2 (Step S1208).

As described above, according to the stepping motor control circuit of the present embodiment, when the rotation detecting circuit 108 has not detected the induced signal VRs exceeding the reference threshold voltage Vcomp in the first section T1a, and has detected the induced signal VRs in the second section, the third section subsequent to the second section is lengthened and the driving of the stepping motor 107 is controlled based on patterns of the induced signal VRs in the first to fourth sections.

In this way, when the determination value in the second section T1b is “1”, since the third section T2 is lengthened by the predetermined time by determining that the phase shift of the induced signal VRs has occurred, driving control with an appropriate driving pulse is performed by exacting determining an extra driving force. Further, although the phase of an induced signal has been shifted due to variation of the stepping motor and the like, the extra driving force can be exactly determined.

In addition, according to the analog electronic watch of the present embodiment, the driving control with the appropriate driving pulse is performed by exacting determining the extra driving force. Moreover, although the phase of the induced signal has been shifted due to the variation of the stepping motor and the like, the extra driving force can be exactly determined, so that the time counting operation can be exactly performed.

Next, a stepping motor control circuit and an analog electronic watch according to another embodiment of the present invention will be described.

The block diagram in another embodiment and the configuration of a stepping motor are equal to those of FIGS. 1 and 2.

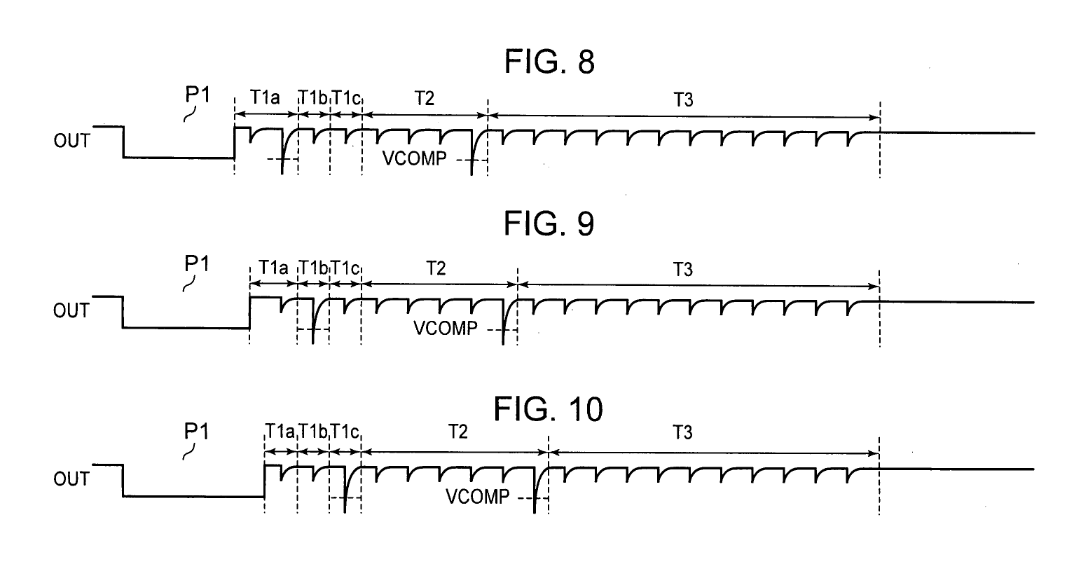

FIGS. 8 to 10 are timing charts when the stepping motor 107 is driven by the main driving pulse P1 according to another embodiment.

In FIGS. 8 to 10, P1 denotes both a main driving pulse and a section in which the rotor 202 is rotated by the main driving pulse P1. Each main driving pulse P1 has a rectangular waveform shape and a pulse width changed proportionally to the magnitude of driving energy.

The detection section T is divided into a first section T1a which denotes a predetermined time immediately after driving with the main driving pulse P1, a fifth section T1b which denotes a predetermined time after the first section T1a, a sixth section T1c which denotes a predetermined time after the fifth section T1b, a third section T2 which denotes a predetermined time after the sixth section, and a fourth section T3 which denotes a predetermined time after the third section T2. In this way, the entire detection section T starting from immediately after the driving with the main driving pulse P1 is divided into a plurality of sections (in the present embodiment, five sections T1a, T1b, T1c, T2 and T3). That is, in another embodiment, the second section T1b is equally divided into the fifth section T1b and the sixth section T1c. However, in the present embodiment, a mask section, which is a period in which the induced signal VRs is not detected, is not provided.

When the rotor 202 is employed as the center and the XY coordinate space area, in which the main magnetic pole of the rotor 202 is located by the rotation thereof, is divided into the first to fourth quadrants I to IV, the first, fifth, sixth, third and fourth sections T1a, T1b, T1c, T2 and T3 can be defined as follows.

That is, the detection section for detecting the rotation of the rotor 202 is divided into the first section T1a immediately after the driving with the main driving pulse P1, the fifth section T1b after the first section T1a, the sixth section T1c after the fifth section T1b, the third section T2 after the sixth section T1c, and the fourth section T3 after the third section T2. In a normal load state, the first section T1a serves as a section for determining the rotation state of the rotor 202 in the forward direction in the third quadrant III of an XY coordinate space employing the rotor 202 as the center, the fifth section T1b and the sixth section T1c serve as sections for determining the rotation state of the rotor 202 in the forward direction and the initial rotation state of the rotor 202 in the backward direction in the third quadrant III, the third section T2 serves as a section for determining the initial rotation state of the rotor 202 in the backward direction in the third quadrant III, and the fourth section T3 serves as a section for determining the rotation state of the rotor 202 after the initial rotation of the rotor 202 in the backward direction in the third quadrant III.

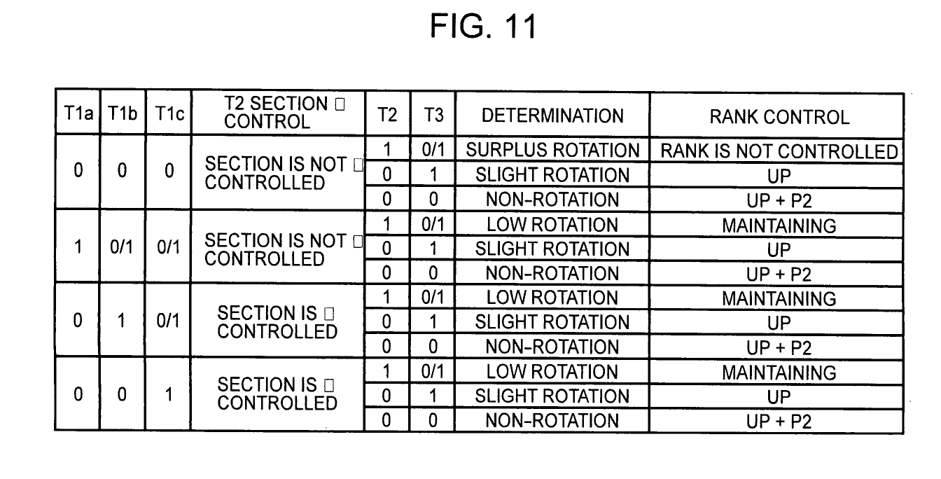

FIG. 11 is a determination chart obtained by collecting operations according to another embodiment, which is stored in the control circuit 103 in advance.

As illustrated in FIG. 11, when the rotation detecting circuit 108 detects the existence of the induced signal VRs exceeding the reference threshold voltage Vcomp, the control circuit 103 generates a determination pattern (a determination value of the first section T1a, a determination value of the fifth section T1b, a determination value of the sixth section T1c, a determination value of the third section T2, and a determination value of the fourth section T3) for the detection time of the induced signal VRs, and controls the main driving pulse generating circuit 104 and the correction driving pulse generating circuit 105 with reference to the determination chart of FIG. 11 stored in the control circuit 103. In detail, the control circuit 103 performs driving pulse control such as pulse up or pulse down of the main driving pulse P1 or driving with the correction driving pulse P2, thereby controlling the rotation of the stepping motor 107.

For example, in the case of a pattern (1, 0, 0, 1, 0) as illustrated in FIG. 8, the control circuit 103 determines the driving of the stepping motor 107 driven by the main driving pulse P1 at that time as rotation (low rotation) with appropriate energy in which driving energy is not left, and maintains the rank of the main driving pulse P1 without changing the same (rank maintenance). In such a case, since the determination value of the first section T1a is “1”, the control circuit 103 determines that an appropriate induced signal VRs is generated in the first section T1a and no phase shift of the induced signal VRs occurs, and does not perform section control of the third section T2.

Meanwhile, when the first section T1a has a value of “0” and the fifth section T1b has a value of “1” as illustrated in FIG. 9, the control circuit 103 determines that the phase shift of the induced signal VRs has occurred to perform section control of the third section T2, thereby lengthening the third section T2 immediately after the fifth section T1b by a predetermined time. That is, when the pattern of the first section T1a and the fifth section T1b is (0, 1), the control circuit 103 determines that the induced signal VRs has been generated after being delayed by a constant time (the phase has been shifted), and lengthens the third section T2 immediately after the fifth section T1b by a first predetermined time although the induced signal VRs is to be generated in the first section T1a under ordinary circumstances.

Thus, in the example of FIG. 9, since the pattern is (0, 1, 0, 0, 1) when the section control is not performed, the rotation state of the stepping motor 107 is determined as slight rotation and a pulse-up operation is unnecessarily performed, so that energy may be wasted. However, since the section control is performed and the pattern (0, 1, 0, 1, 0) is obtained, the rotation state of the stepping motor 107 is determined as low rotation and the main driving pulse P1 is maintained without any change. That is, driving with an appropriate main driving pulse P1 is performed, so that energy can be prevented from being wasted.

Further, when the first section T1a and the fifth section T1b have a value of “0” and the sixth section T1c has a value of “1” as illustrated in FIG. 10, the control circuit 103 determines that large phase shift of the induced signal VRs has occurred to perform the section control of the third section T2, thereby lengthening the third section T2 consequent to the sixth section T1c by a predetermined time. That is, when the pattern of the first section T1a, the fifth section T1b and the sixth section T1c is (0, 0, 1), the control circuit 103 determines that the induced signal VRs has been generated after being significantly delayed by a constant time (the phase has been shifted), and lengthens the third section T2 by a second predetermined time longer than the first predetermined time by a predetermined time.

Thus, in the example of FIG. 10, since the pattern is (0, 0, 1, 0, 1) when the section control is not performed, the rotation state of the stepping motor 107 is determined as slight rotation and the pulse-up operation is unnecessarily performed, so that energy may be wasted. However, since the section control is performed and the pattern (0, 0, 1, 1, 0) is obtained, the rotation state of the stepping motor 107 is determined as low rotation and the main driving pulse P1 is maintained without any change. That is, the driving with the appropriate main driving pulse P1 is performed, so that energy can be prevented from being wasted.

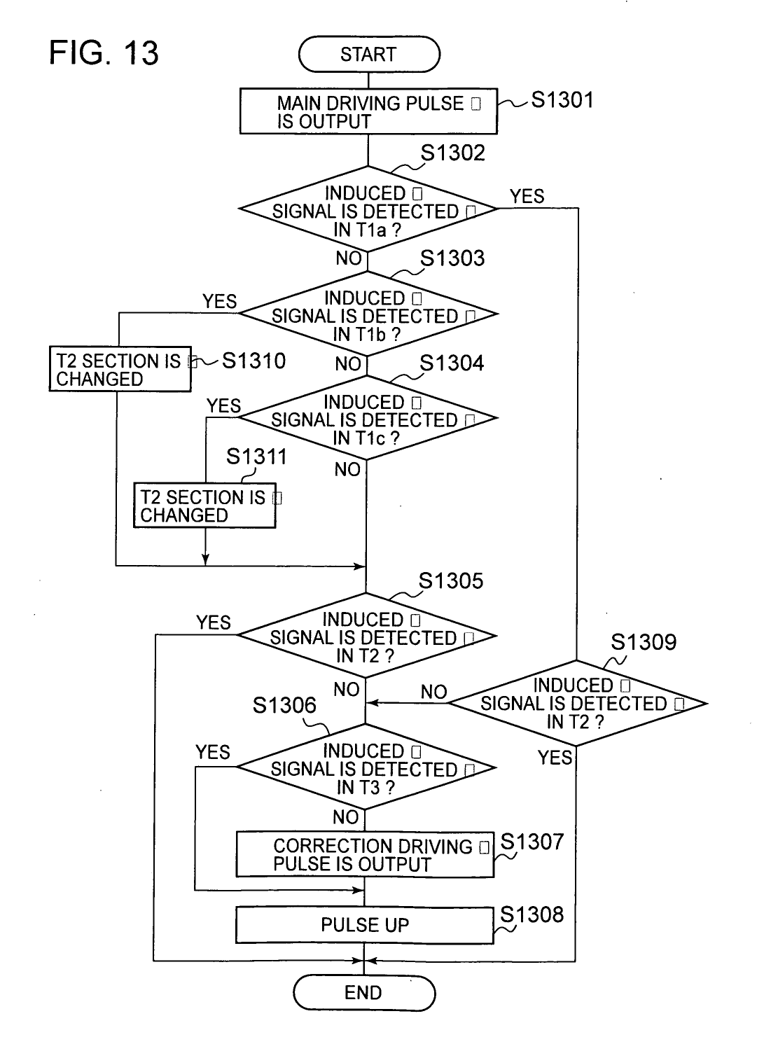

FIG. 13 is a flowchart illustrating the procedure of another embodiment, which mainly illustrates the procedure of the control circuit 103.

Hereinafter, the operations of the stepping motor control circuit and the analog electronic watch according to another embodiment of the present invention will be described with reference to FIGS. 1, 2, 8 to 11 and FIG. 13 while focusing on the difference relative to that of the previous embodiment.

In FIG. 13, the control circuit 103 outputs a main driving pulse control signal to the main driving pulse generating circuit 104 such that the stepping motor 107 is rotated by the main driving pulse P1 with predetermined energy (Step S1301).

When it is determined that the rotation detecting circuit 108 detects no induced signal VRs exceeding the reference threshold voltage Vcomp in any one of the first section T1a, the fifth section T1b, the sixth section T1c, the third section T2 and the fourth section T3 (the stepping motor 107 is not rotated in any one of the first section T1a, the fifth section T1b, the sixth section T1c, the third section T2 and the fourth section T3), that is, when it is determined that the detection pattern is (0, 0, 0, 0, 0), in other words, when the rotation state of the stepping motor 107 is determined as non-rotation (Steps S1302, S1303, S1304, S1305 and S1306), the control circuit 103 outputs a correction driving pulse control signal to the correction driving pulse generating circuit 105 such that the correction driving pulse generating circuit 105 outputs the correction driving pulse P2 (Step S1307), and outputs a pulse up control signal to the main driving pulse generating circuit 104, thereby controlling the rank of the main driving pulse P1 to be up by one rank (Step S1308). The motor driver circuit 106 rotates the stepping motor 107 by using a main driving pulse P1 after one rank up in the next driving.

In process step S1306, when it is determined that the rotation detecting circuit 108 has detected the induced signal VRs exceeding the reference threshold voltage Vcomp in the fourth section T3 (the detection pattern is (0, 0, 0, 0, 1)), that is, when the rotation state of the stepping motor 107 is determined as slight rotation, the control circuit 103 proceeds to the process step S1308 to perform a pulse-up operation without outputting the correction driving pulse P2.

In process step S1305, when it is determined that the rotation detecting circuit 108 has detected the induced signal VRs exceeding the reference threshold voltage Vcomp in the third section T2 (the detection pattern is (0, 0, 0, 1, 0/1)), that is, when the rotation state of the stepping motor 107 is determined as surplus rotation, the control circuit 103 performs no rank control of the main driving pulse P1.

In process step S1304, when it is determined that the rotation detecting circuit 108 has detected the induced signal VRs exceeding the reference threshold voltage Vcomp in the sixth section T1c (the initial pattern of three sections is (0, 0, 1)), the control circuit 103 performs section control to lengthen the third section T2 consequent to the sixth section T1c by the second predetermined time, and then proceeds to the process step S1305 (Step S1311) (refer to FIG. 10).

In process step S1303, when it is determined that the rotation detecting circuit 108 has detected the induced signal VRs exceeding the reference threshold voltage Vcomp in the fifth section T1b (the initial pattern of two sections is (0, 1)), the control circuit 103 performs the section control to lengthen the third section T2 immediately after the fifth section T1b by the first predetermined time, and then proceeds to the process step S1305 (Step S1310) (refer to FIG. 9).

Meanwhile, in process step S1302, in the case of determining that the rotation detecting circuit 108 has detected the induced signal VRs exceeding the reference threshold voltage Vcomp in the first section T1a, the control circuit 103 proceeds to the process step S1306 when determining that the induced signal VRs exceeding the reference threshold voltage Vcomp is not detected in the third section T2, but performs no rank control when determining that the induced signal VRs exceeding the reference threshold voltage Vcomp has been detected in the third section T2 (Step S1309).

As described above, according to the stepping motor control circuit of another embodiment, when the determination value of the first section T1a is “0” and the determination value of the fifth section T1b is “1”, the third section T2 immediately after the fifth section T1b is lengthened by a first predetermined length. Further, when the determination value of the first section T1a and the fifth section T1b is “0” and the determination value of the sixth section T1c is “1”, since the third section T2 consequent to the sixth section T1c is lengthened by a second predetermined length longer than the first predetermined length, and the driving of the stepping motor 107 is controlled by selecting a driving pulse based on a pattern of the induced signal VRs in the first section T1a, the third section T2 and the sixth section T1c, driving control with an appropriate driving pulse is performed by exacting determining an extra driving force. Furthermore, although the phase of an induced signal has been shifted due to variation of the stepping motor and the like, the extra driving force can be exactly determined.

In addition, according to the analog electronic watch of another embodiment, the driving control with the appropriate driving pulse is performed by exacting determining the extra driving force. Moreover, although the phase of the induced signal has been shifted due to the variation of the stepping motor and the like, the extra driving force can be exactly determined, so that the time counting operation can be exactly performed.

Further, in the previous embodiment, since the energy of each main driving pulse P1 is changed, the duty ratios or the pulse widths are configured to be different from each other. However, the driving energy can be changed by changing a pulse voltage.

Furthermore, the present invention can be applied to a stepping motor for driving a calendar and the like, in addition to time hands.

In addition, the electronic watch has been described as an application of a stepping motor. However, the invention can be applied to an electronic apparatus using a motor.

The stepping motor control circuit according to the invention can be applied to various electronic apparatuses using a stepping motor.

Moreover, the electronic watch according to the invention can be applied to various analog electronic watches including an analog electronic watch or clock having various calendar functions such as an analog electronic wrist watch having a calendar function, or an analog electronic table clock having a calendar function.

What is claimed is:

1. A stepping motor control circuit comprising:
a rotation detecting means for detecting an induced signal generated by rotation of a rotor of a stepping motor, and detecting a rotation state of the stepping motor according to whether the induced signal exceeds a predetermined reference threshold voltage in a predetermined detection section; and
a control means for controlling driving of the stepping motor by using any one of a plurality of main driving pulses having energy different from each other or a correction driving pulse having energy higher than energy of each main driving pulse according to a detection result of the rotation detecting means,
wherein the detection section is divided into a first section immediately after driving with the main driving pulse, a second section after the first section, a third section after the second section, and a fourth section after the third section, and
the control means lengthens the third section subsequent to the second section when the rotation detecting means has detected an induced signal exceeding the reference threshold voltage in the second section, and controls the driving of the stepping motor by selecting a driving pulse based on a pattern of an induced signal in the first to fourth sections.

2. A stepping motor control circuit according to claim 1, wherein, when the rotation detecting means has detected an induced signal exceeding the reference threshold voltage in the first section, the control means does not lengthen the third section subsequent to the second section although the rotation detecting means has detected an induced signal exceeding the reference threshold voltage in the second section subsequent to the first section.

3. A stepping motor control circuit according to claim 1, wherein, when the third section is lengthened, the control means shortens the fourth section subsequent to the third section such that a length of the detection section is not changed.

4. A stepping motor control circuit according to claim 2, wherein, when the third section is lengthened, the control means shortens the fourth section subsequent to the third section such that a length of the detection section is not changed.

5. A stepping motor control circuit according to claim 1, wherein the main driving pulses have a comb-tooth shape and pulse widths of the main driving pulses are equal to each other.

6. A stepping motor control circuit according to claim 2, wherein the main driving pulses have a comb-tooth shape and pulse widths of the main driving pulses are equal to each other.

7. A stepping motor control circuit according to claim 3, wherein the main driving pulses have a comb-tooth shape and pulse widths of the main driving pulses are equal to each other.

8. A stepping motor control circuit according to claim 4, wherein the main driving pulses have a comb-tooth shape and pulse widths of the main driving pulses are equal to each other.

9. A stepping motor control circuit comprising:
a rotation detecting means for detecting an induced signal generated by rotation of a rotor of a stepping motor, and detects a rotation state of the stepping motor according to whether the induced signal exceeds a predetermined reference threshold voltage in a predetermined detection section; and
a control means for controlling driving of the stepping motor by using any one of a plurality of main driving pulses having energies different from each other or a correction driving pulse having energy higher than energy of each main driving, pulse according to a detection result of the rotation detecting means,
wherein the detection section is divided into a first section immediately after driving with the main driving pulse, a fifth section after the first section, a sixth section after the fifth section, a third section after the sixth section, and a fourth section after the third section, and
the control means lengthens the third section immediately after the fifth section by a first predetermined length when the rotation detecting means has not detected an induced signal exceeding the reference threshold voltage in the first section and has detected the induced signal in the fifth section, and controls the driving of the stepping motor by selecting a driving pulse based on a pattern of an induced signal in the first, third and sixth sections.

10. A stepping motor control circuit according to claim 9, wherein the control means lengthens the third section subsequent to the sixth section by a second predetermined length longer than the first predetermined length when the rotation detecting means has not detected an induced signal exceeding the reference threshold voltage in the first section and the fifth section and has detected the induced signal in the sixth section, and controls the driving of the stepping motor by selecting a driving pulse based on a pattern of an induced signal in the first, third and sixth sections.

11. A stepping motor control circuit according to claim 9, wherein, when the third section is lengthened, the control means shortens the fourth section subsequent to the third section.

12. A stepping motor control circuit according to claim 10, wherein, when the third section is lengthened, the control means shortens the fourth section subsequent to the third section.

13. A stepping motor control circuit according to claim 9, wherein the main driving pulses have a rectangular waveform shape and pulse widths of the main driving pulses are different from each other.

14. A stepping motor control circuit according to claim 10, wherein the main driving pulses have a rectangular waveform shape and pulse widths of the main driving pulses are different from each other.

15. A stepping motor control circuit according to claim 11, wherein the main driving pulses have a rectangular waveform shape and pulse widths of the main driving pulses are different from each other.

16. A stepping motor control circuit according to claim 12, wherein the main driving pulses have a rectangular waveform shape and pulse widths of the main driving pulses are different from each other.

17. An analog electronic watch including a stepping motor for rotating time hands and a stepping motor control circuit for controlling the stepping motor, wherein the stepping motor control circuit according to claim 1 is used as the stepping motor control circuit.

18. An analog electronic watch including a stepping motor for rotating time hands and a stepping motor control circuit for controlling the stepping motor, wherein the stepping motor control circuit according to claim 9 is used as the stepping motor control circuit.
